(19) United States
(12) Patent Application Publication
(10) Pub. No.: US 2026/0099745 A1
(43) Pub. Date: Apr. 9, 2026

(54) Computer-Readable Recording Medium Storing Quantum Circuit Information Generation Program, Quantum Circuit Information Generation Method, and Information Processing Device

(71) Applicant: Fujitsu Limited, Kawasaki-shi, Kanagawa (JP)

(72) Inventors: Hiroshi FUJITA, Yokosuka (JP); Akihiko KASAGI, Kawasaki (JP)

(73) Assignee: Fujitsu Limited, Kawasaki-shi, Kanagawa (JP)

(21) Appl. No.: 18/907,627

(22) Filed: Oct. 7, 2024

(30) Foreign Application Priority Data
Nov. 27, 2023 (JP) 2023-199692

(51) Int. Cl. G06N 10/20

(52) U.S. Cl. CPC G06N 10/20

(57) ABSTRACT

A non-transitory computer-readable recording medium storing a quantum circuit information generation program for causing a computer to execute processing including: in a target quantum circuit that includes a plurality of partial circuits, specifying a type of a partial circuit that appears in the target quantum circuit; and storing, for each specified type, only one piece of first circuit information that enables generation of one partial circuit that belongs to the specified type, in a storage unit, and storing, in the storage unit, second circuit information that defines the target quantum circuit by representing, for each specified type, at least one partial circuit that belongs to the specified type by using reference information that enables reference to the first circuit information stored in the storage unit.

### CROSS-REFERENCE TO RELATED APPLICATION

This application is based upon and claims the benefit of priority of the prior Japanese Patent Application No. 2023-199692, filed on Nov. 27, 2023, the entire contents of which are incorporated herein by reference.

### FIELD

The embodiment discussed herein is related to a quantum circuit information generation program, a quantum circuit information generation method, and an information processing device.

### BACKGROUND

Since before, it is needed to solve problems such as price determination of derivatives by quantum calculation. For example, quantum circuit information defining a quantum circuit for solving a target problem may be generated by a classical computer, and the target problem may be solved by a quantum computer based on the generated quantum circuit information.

As prior art, for example, there is a technology in which each block in a gate circuit representing a quantum program is pre-compiled, and the quantum program is iteratively executed in a quantum processor by using the pre-compiled blocks as static.

Japanese National Publication of International Patent Application No. 2022-547989 is disclosed as related art.

However, in the prior art, when the number of qubits forming a quantum circuit or the like increases according to complexity of a problem, memory usage or the like needed when quantum circuit information generated by a classical computer is stored increases exponentially.

In one aspect, an object of an embodiment is to reduce memory usage needed when quantum circuit information is stored.

### SUMMARY

According to an aspect of the embodiments, there is provided a non-transitory computer-readable recording medium storing a quantum circuit information generation program for causing a computer to execute processing including: in generating of quantum circuit information indicating a target quantum circuit that includes a plurality of partial circuits, specifying, for each partial circuits of the plurality of partial circuits included in the target quantum circuit, a type of the each partial circuit; storing, for each specified type of one or more of specified types obtained by performing the specifying for the plurality of partial circuits, only one piece of first circuit information in a memory of the computer, the first circuit information including a configuration to generate any one partial circuit of partial circuits that belong to the specified type; and generating, by using one or more pieces of reference information, second circuit information that defines the target quantum circuit to store the generated second circuit information in the memory, each piece of the one or more pieces of reference information being information that includes a reference to the first circuit information associated with a corresponding type of the one or more of specified types, the generating of the second circuit information including converting, in the second circuit information, at least one or more partial circuits belonging to any one type of the one or more of specified types among the plurality of partial circuits included in the target quantum circuit to a representation using a corresponding piece of reference information among the one or more pieces of reference information.

The object and advantages of the invention will be realized and attained by means of the elements and combinations particularly pointed out in the claims.

It is to be understood that both the foregoing general description and the following detailed description are exemplary and explanatory and are not restrictive of the invention.

BRIEF DESCRIPTION OF DRAWINGS

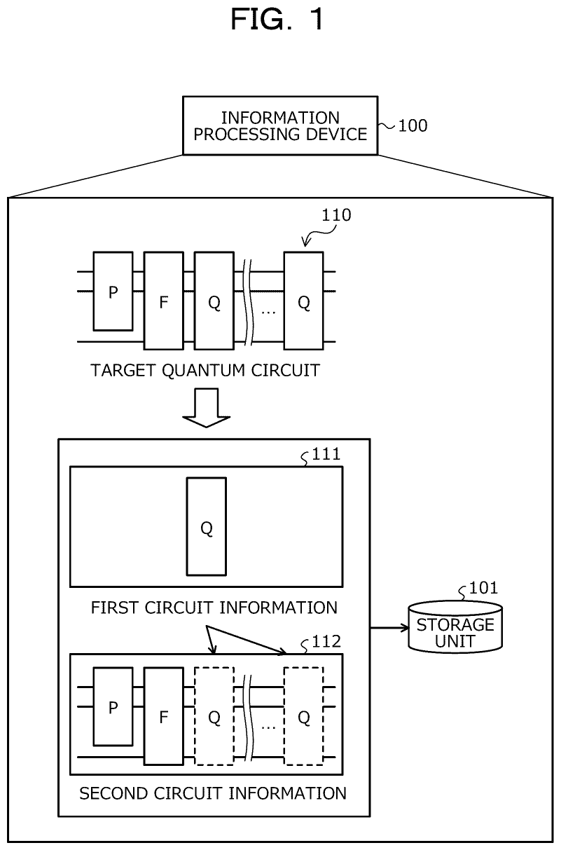

FIG. 1 is an explanatory diagram illustrating one example of an information processing method according to an embodiment;

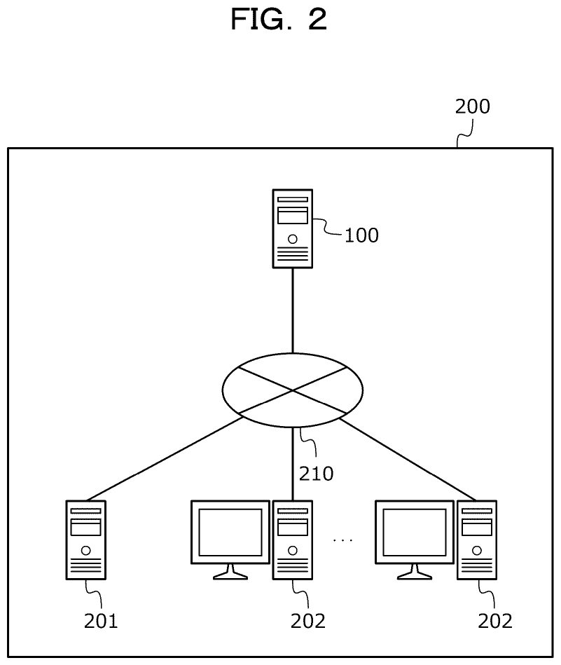

FIG. 2 is an explanatory diagram illustrating an example of an information processing system 200;

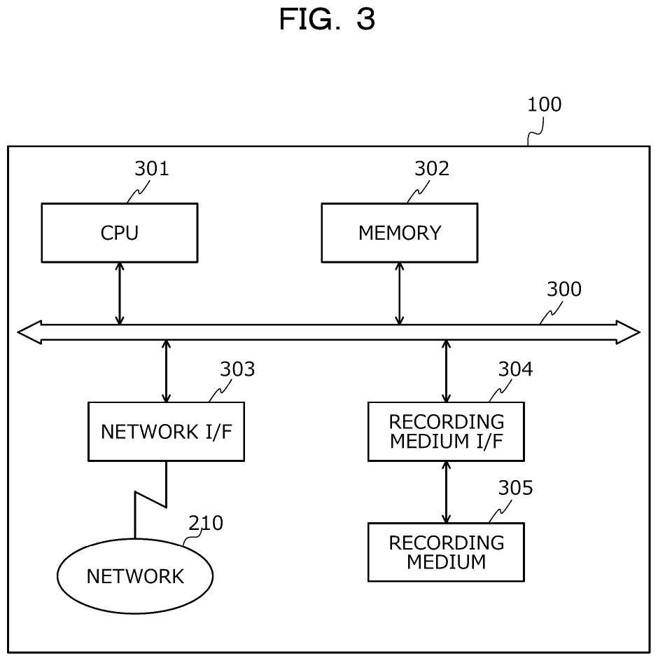

FIG. 3 is a block diagram illustrating a hardware configuration example of an information processing device 100;

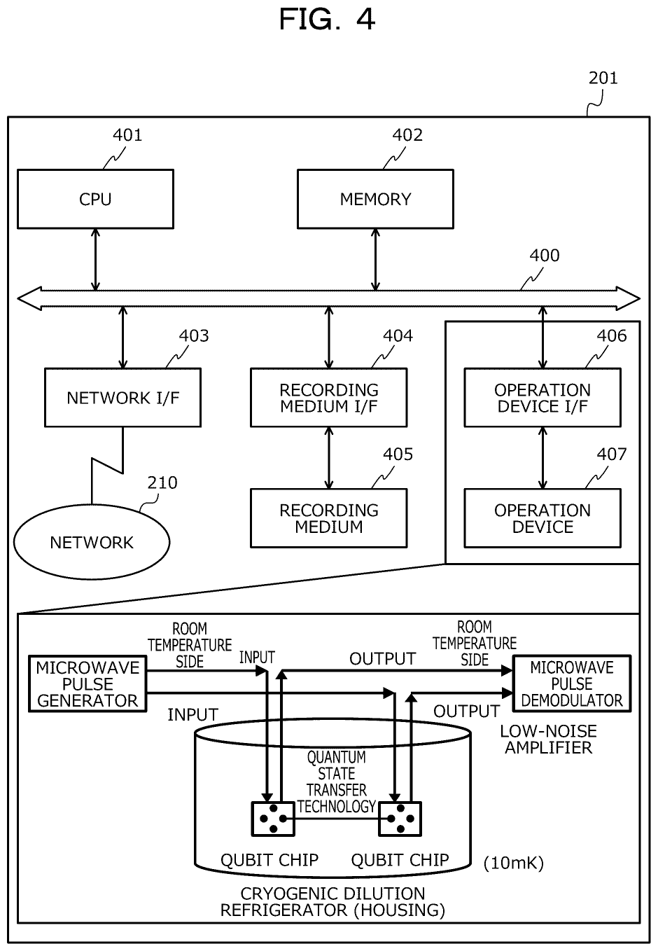

FIG. 4 is a block diagram illustrating a hardware configuration example of a quantum calculation device 201;

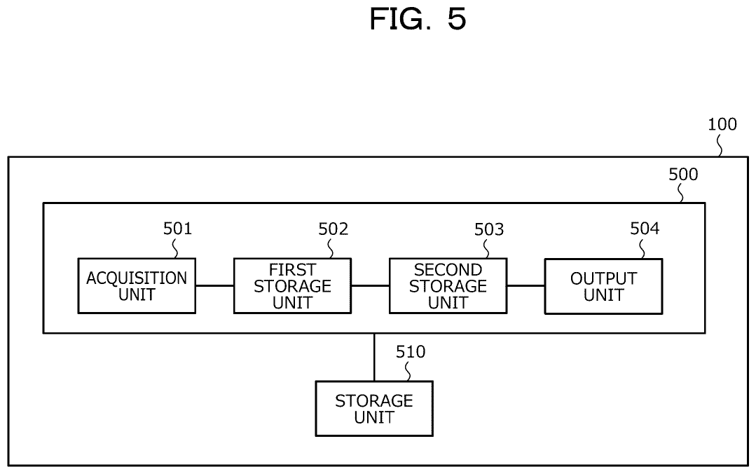

FIG. 5 is a block diagram illustrating a functional configuration example of the information processing device 100;

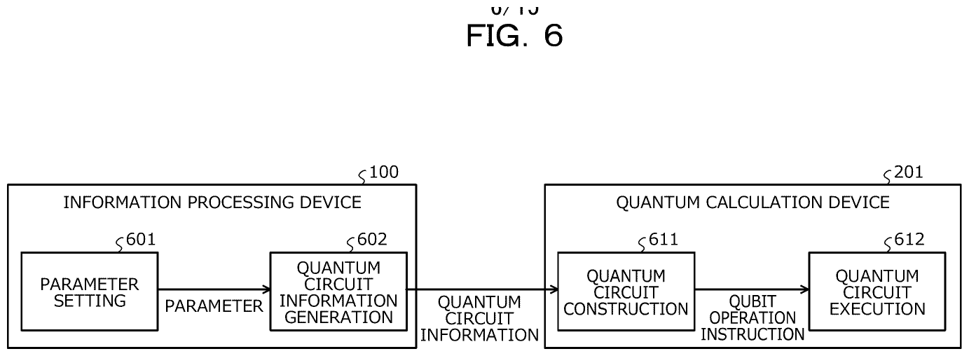

FIG. 6 is an explanatory diagram illustrating a flow of an operation of the information processing system 200;

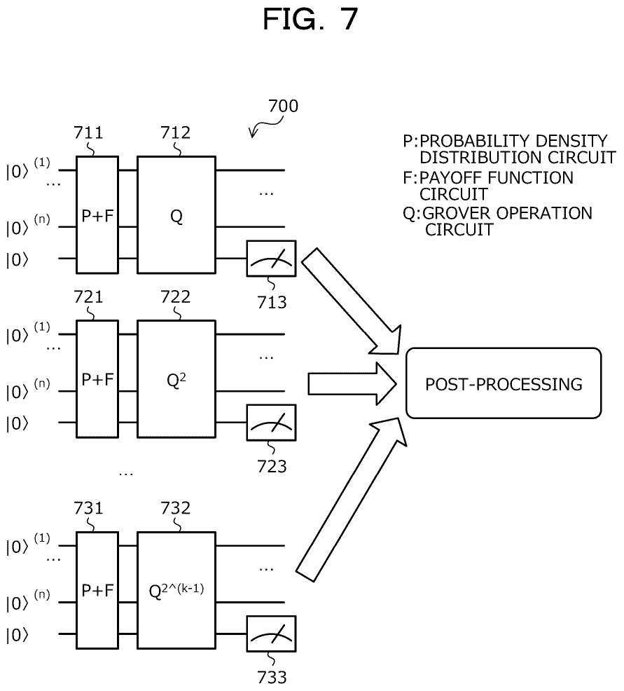

FIG. 7 is an explanatory diagram (part 1) illustrating an example of an operation of the information processing device 100;

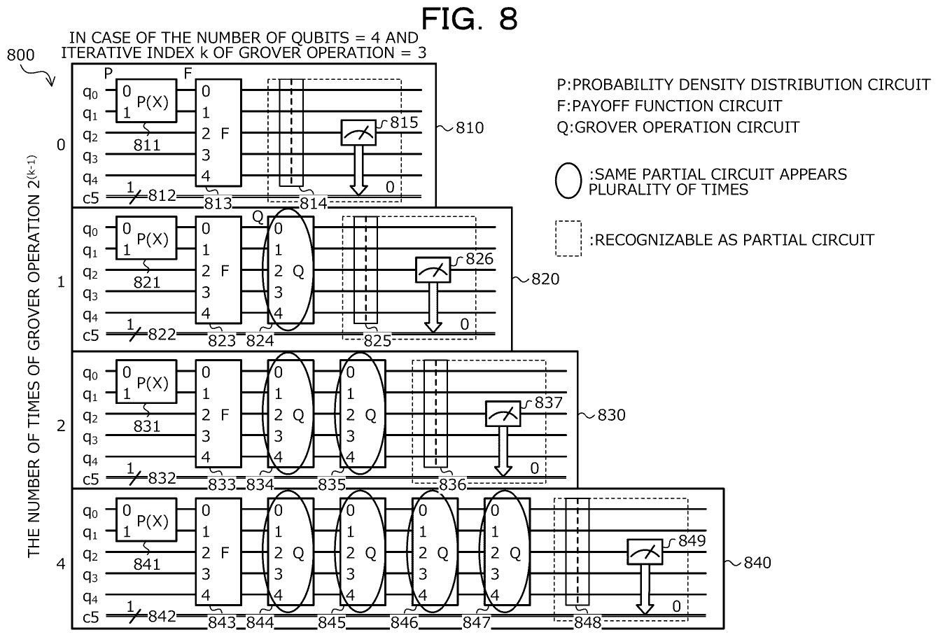

FIG. 8 is an explanatory diagram (part 2) illustrating an example of the operation of the information processing device 100;

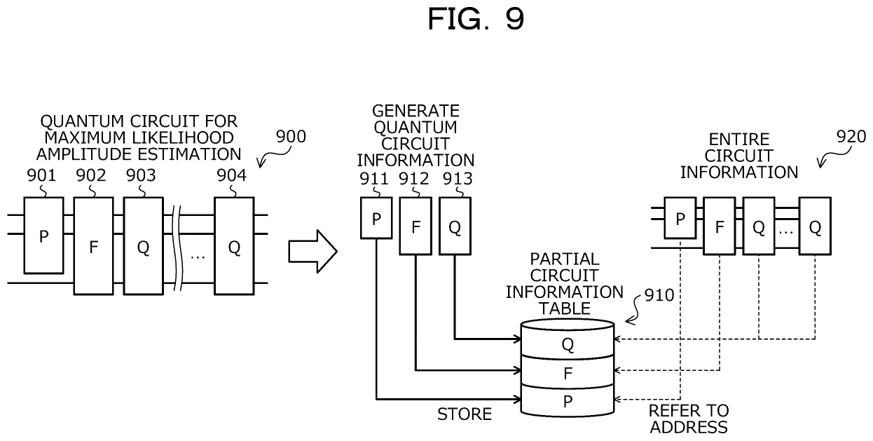

FIG. 9 is an explanatory diagram (part 3) illustrating an example of the operation of the information processing device 100;

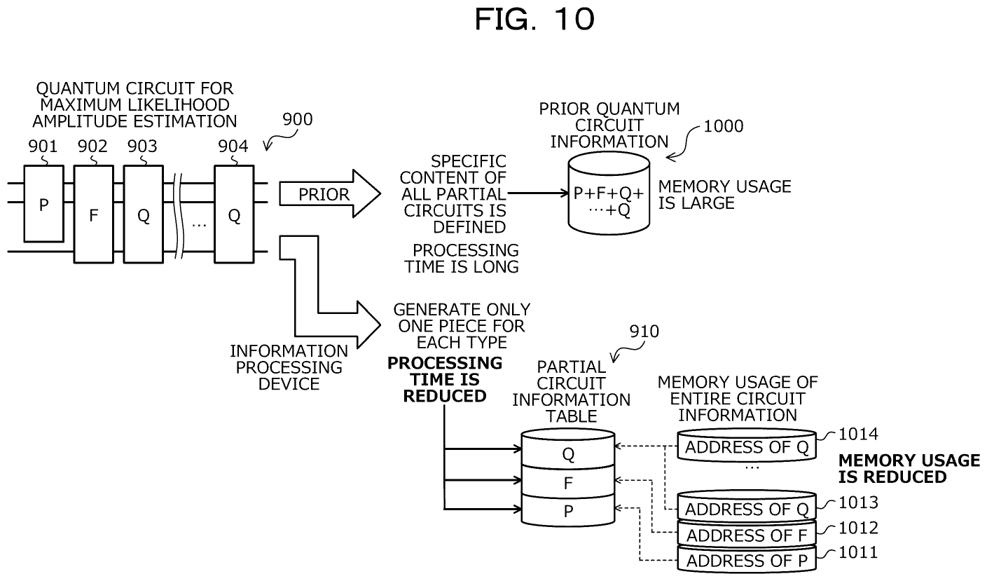

FIG. 10 is an explanatory diagram (part 4) illustrating an example of the operation of the information processing device 100;

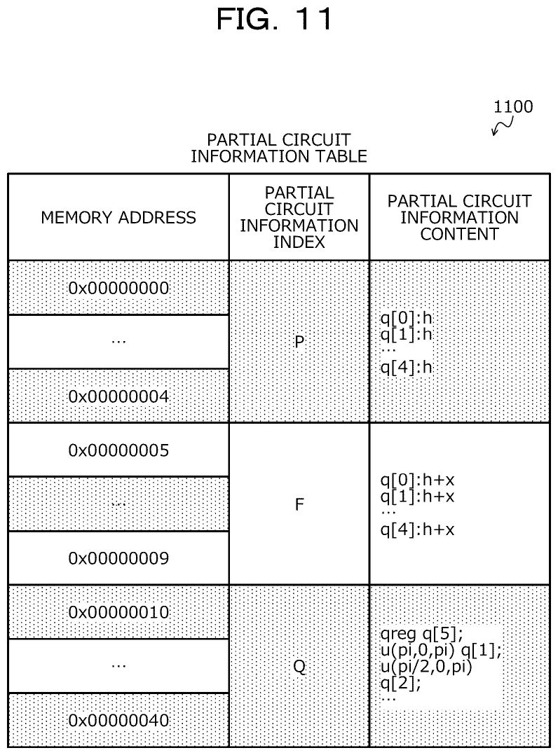

FIG. 11 is an explanatory diagram (part 1) illustrating an example of quantum circuit information;

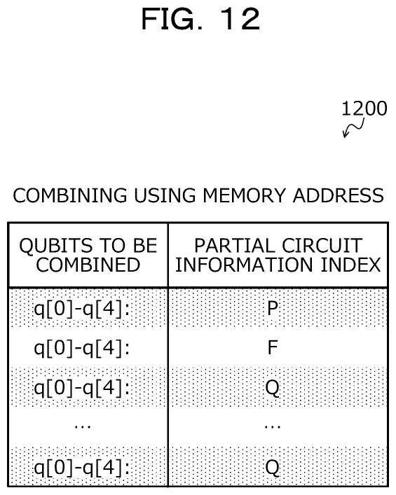

FIG. 12 is an explanatory diagram (part 2) illustrating an example of the quantum circuit information;

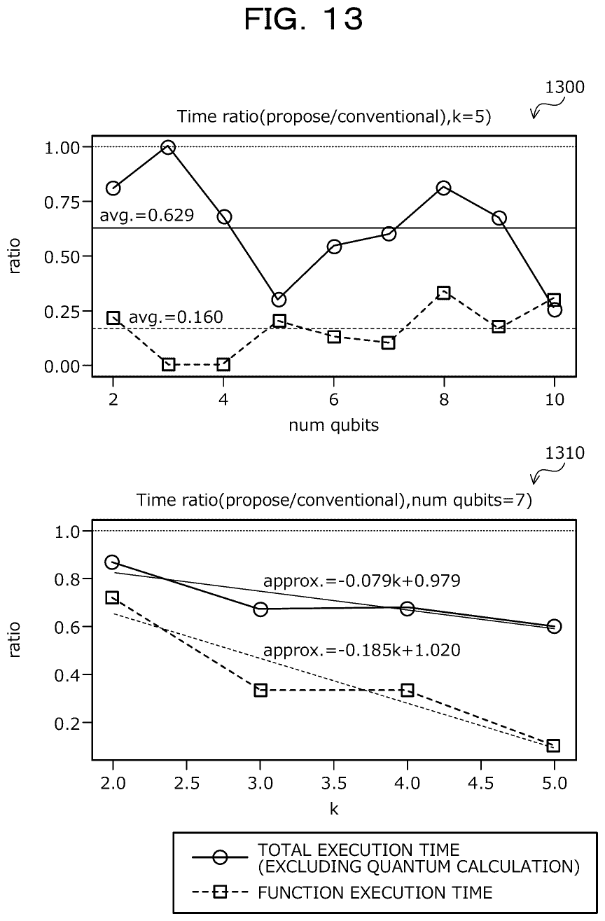

FIG. 13 is an explanatory diagram (part 1) illustrating a possible result as an example of effects of the information processing device 100;

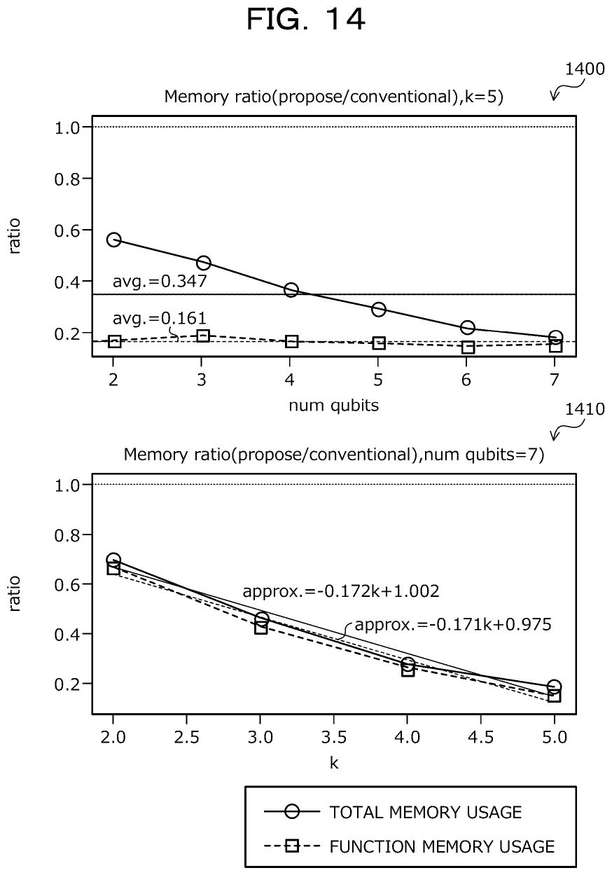

FIG. 14 is an explanatory diagram (part 2) illustrating a possible result as an example of the effects of the information processing device 100; and

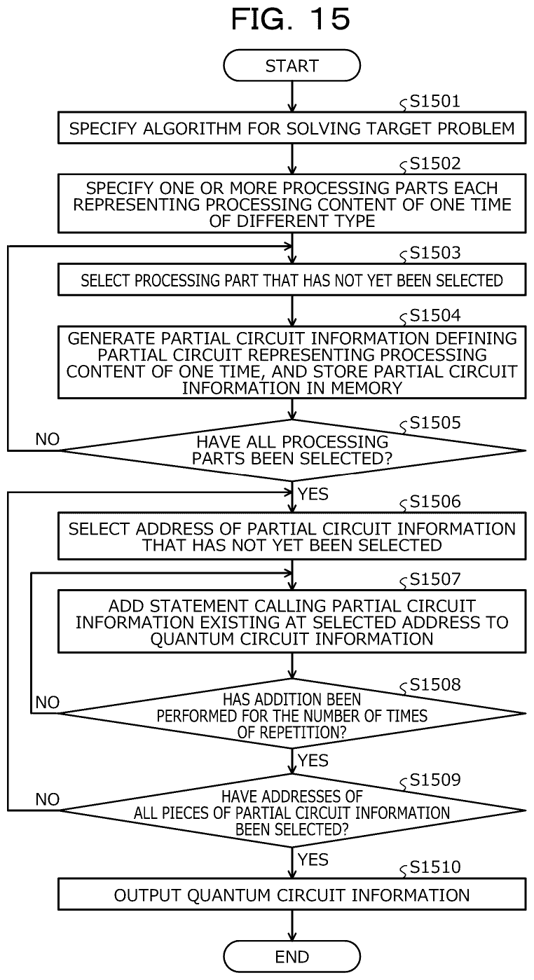

FIG. 15 is a flowchart illustrating an example of an overall processing procedure.

### DESCRIPTION OF EMBODIMENTS

Hereinafter, an embodiment of a quantum circuit information generation program, a quantum circuit information generation method, and an information processing device will be described in detail with reference to the drawings.

### One Example of Information Processing Method According to Embodiment

FIG. 1 is an explanatory diagram illustrating one example of an information processing method according to the embodiment. An information processing device 100 is a computer for generating quantum circuit information defining a quantum circuit for solving a problem.

Examples of the information processing device 100 include a server, a personal computer (PC), or the like.

Since before, it is needed to solve problems in a financial field such as price determination of derivatives by quantum calculation, in addition to problems in a chemical field. Examples of the derivatives include a derivative option or the like. The derivative option is a right to trade an underlying asset at a pre-set price in the future. The underlying asset is a stock or the like. For example, by estimating time development of the price of the underlying asset, the price of the underlying asset at the time of future trade is set.

Here, when a problem in the financial field may be solved at high speed by quantum calculation, it is considered that it becomes easy to cope with complication of a calculation model, an increase in the number of products that may be handled during business hours, or the like. Therefore, when the problem in the financial field may be solved at high speed by the quantum calculation, it is considered that financial transactions may be activated and an economic effect may be increased. For example, quantum circuit information defining a quantum circuit for solving a target problem may be generated by a classical computer, and a quantum circuit may be actually prepared based on the generated quantum circuit information and the target problem may be solved by a quantum computer.

However, a processing time needed when the classical computer generates the quantum circuit information, memory usage needed when the classical computer stores the generated quantum circuit information, or the like may increase. For example, depending on complexity of the target problem, the number of qubits forming the quantum circuit, a depth of the quantum circuit, or the like may increase, leading to an increase in scale of the quantum circuit. For example, as the scale of the quantum circuit increases, the processing time needed when the classical computer generates the quantum circuit information, the memory usage needed when the classical computer stores the quantum circuit information, or the like exponentially increases. Therefore, there is a problem that performance of the classical computer becomes a bottleneck in solving the target problem, and it becomes difficult to solve the target problem depending on the complexity of the target problem.

Here, in order to solve a problem having practical significance, it is needed to prepare a relatively large-scale quantum circuit. For example, when the problem having practical significance is solved, the number of qubits forming the quantum circuit to be prepared may be several thousands or more. For example, in a case where the target problem is a problem of price determination of the derivative option, quantum circuit information defining the quantum circuit to be prepared is generated according to an algorithm of quantum amplitude estimation. The algorithm of the quantum amplitude estimation includes, for example, a first algorithm that uses quantum phase estimation and a second algorithm that does not use the quantum phase estimation capable of reducing the number of qubits as compared with the first algorithm that uses the quantum phase estimation.

The second algorithm generates, for example, quantum circuit information defining a quantum circuit corresponding to maximum likelihood amplitude estimation.

For the second algorithm, for example, Reference Document 1 described below may be referred to. According to the second algorithm, for example, the number of qubits forming the quantum circuit to be prepared may be 8000 or more. Similarly, according to the second algorithm, for example, a depth of the quantum circuit to be prepared may be 5.4×10\hat{ }7 or more. Therefore, there is a problem that it is difficult to solve the problem having practical significance. For the difficulty of solving the problem having practical significance, for example, Reference Document 2 described below may be referred to.

Reference Document 1: Suzuki, Yohichi, et al. “Amplitude estimation without phase estimation.” Quantum Information Processing 19 (2020): 1-17.

Reference Document 2: Chakrabarti, Shouvanik, et al. “A threshold for quantum advantage in derivative pricing.” Quantum 5 (2021): 463.

Thus, in the present embodiment, an information processing method capable of reducing memory usage needed when quantum circuit information is stored will be described. Furthermore, according to the information processing method, it is possible to reduce a processing time needed when the quantum circuit information is generated.

In FIG. 1, the information processing device 100 includes a storage unit 101. The information processing device 100 stores a predetermined algorithm for solving a target problem in the storage unit 101. For example, the predetermined algorithm specifies the target problem based on a specified parameter, and defines processing content for solving the target problem. The predetermined algorithm defines the processing content for solving the target problem by, for example, the maximum likelihood amplitude estimation based on the specified parameter. A target quantum circuit 110 may be handled as having a plurality of partial circuits, for example. In the target quantum circuit 110, the same partial circuit may appear twice or more.

(1-1) The information processing device 100 specifies a type of the partial circuit that appears in the target quantum circuit 110. For example, the information processing device 100 specifies a type of the partial circuit that appears twice or more in the target quantum circuit 110. For example, the information processing device 100 specifies the type of the partial circuit that appears twice or more in the target quantum circuit 110 based on the predetermined algorithm and the specified parameter. The type identifies, for example, a partial circuit that implements a predetermined function based on the predetermined algorithm. The predetermined function is, for example, a function specified in the predetermined algorithm. The predetermined function may be, for example, a function separated by the information processing device 100 from the entire function of the predetermined algorithm. In the example of FIG. 1, for example, the information processing device 100 specifies a type Q of a partial circuit that appears twice or more in the target quantum circuit 110 corresponding to the maximum likelihood amplitude estimation and performs a Grover operation.

(1-2) The information processing device 100 stores first circuit information 111 in the storage unit 101, and stores second circuit information 112 in the storage unit 101. The first circuit information 111 enables generation of one partial circuit belonging to the specified type. The second circuit information 112 defines the target quantum circuit 110 by representing, for each specified type, at least one partial circuit belonging to the specified type by using reference information that enables reference to the first circuit information 111 stored in the storage unit 101. The reference information is, for example, a label that identifies the first circuit information 111. The reference information is, for example, an address representing a storage location of the first circuit information 111 stored in the storage unit 101. For example, the second circuit information 112 may represent, for each specified type, all partial circuits belonging to the specified type by using the reference information that enables reference to the first circuit information 111 stored in the storage unit 101.

For example, the information processing device 100 generates, for each specified type, only one piece of the first circuit information 111 that enables generation of one partial circuit belonging to the specified type. The information processing device 100 generates, for example, the second circuit information 112. For example, the information processing device 100 stores, for each specified type, only one piece of the generated first circuit information 111 in the storage unit 101, and stores the generated second circuit information 112 in the storage unit 101. In the example of FIG. 1, for example, the information processing device 100 generates the first circuit information 111 that enables generation of one partial circuit belonging to the type Q. For example, the information processing device 100 generates the second circuit information 112 defining the target quantum circuit 110 by representing all partial circuits belonging to the type Q by using the reference information that enables reference to the first circuit information 111. For example, information processing device 100 stores the generated first circuit information 111 and the generated second circuit information 112 in the storage unit 101.

Therefore, the information processing device 100 may generate a combination of the first circuit information 111 and the second circuit information 112, serving as quantum circuit information that enables specification of the target quantum circuit 110 to be prepared, and store the combination in the storage unit 101. The information processing device 100 may transmit the combination of the first circuit information 111 and the second circuit information 112 to a quantum computer. Thus, the information processing device 100 may enable preparation of the target quantum circuit 110 by the quantum computer. Furthermore, the information processing device 100 may reduce memory usage needed when the quantum circuit information that enables specification of the target quantum circuit 110 to be prepared is stored. Furthermore, the information processing device 100 may reduce a processing time needed when the quantum circuit information that enables specification of the target quantum circuit 110 to be prepared is generated.

Here, for example, a prior method of generating quantum circuit information in which a relationship between each operation unit such as a gate forming the target quantum circuit 110 and a qubit is described one by one for each operation unit is considered. The prior method generates the quantum circuit information according to, for example, a quantum assembly language (QASM). The QASM is an assembly language for quantum circuits.

In the prior method, the target quantum circuit 110 is recognized not in units of partial circuits but in units of operation units such as gates, and the quantum circuit information is generated. In the prior method, the partial circuit that appears twice or more in the target quantum circuit 110 is not considered. In the prior method, even when there is the partial circuit that appears twice or more in the target quantum circuit 110, a relationship between each operation unit such as a gate forming the partial circuit and a qubit is comprehensively described for all the partial circuits.

On the other hand, the information processing device 100 may describe the partial circuit that appears twice or more in the target quantum circuit 110 in the first circuit information 111. Furthermore, the information processing device 100 may omit, by using the first circuit information 111, at least any one of the partial circuits that appear twice or more in the target quantum circuit 110 without describing the partial circuit in the second circuit information 112. Thus, as compared with the prior method, the information processing device 100 may reduce the memory usage needed when the quantum circuit information that enables specification of the target quantum circuit 110 to be prepared is stored.

Furthermore, the information processing device 100 may reduce the processing time needed when the quantum circuit information that enables specification of the target quantum circuit 110 to be prepared is generated.

Here, a case has been described where the information processing device 100 specifies the type of the partial circuit that appears twice or more in the target quantum circuit 110. However, the present embodiment is not limited to this. For example, the information processing device 100 may specify a type of a partial circuit that appears N times or more in the target quantum circuit 110. N may be, for example, 1. N may be, for example, 3 or more.

Here, a case has been described where the function as the information processing device 100 is implemented by the single computer.

However, the present embodiment is not limited to this. For example, the function as the information processing device 100 may be implemented by cooperation of a plurality of computers. For example, the function as the information processing device 100 may be implemented in a cloud.

### Example of Information Processing System 200

Next, an example of an information processing system 200 to which the information processing device 100 illustrated in FIG. 1 is applied will be described with reference to FIG. 2.

FIG. 2 is an explanatory diagram illustrating an example of the information processing system 200. In FIG. 2, the information processing system 200 includes the information processing device 100, a quantum calculation device 201, and a client device 202.

In the information processing system 200, the information processing device 100 and the quantum calculation device 201 are coupled via a wired or wireless network 210. The network 210 is, for example, a local area network (LAN), a wide area network (WAN), the Internet, or the like.

Furthermore, in the information processing system 200, the information processing device 100 and the client device 202 are coupled via the wired or wireless network 210.

The information processing device 100 is a computer for generating quantum circuit information defining a quantum circuit for solving a target problem. The information processing device 100 acquires a processing request for requesting generation of the quantum circuit information. The processing request may include, for example, a parameter related to the target problem. The information processing device 100 acquires the processing request by receiving the processing request from another computer. The another computer is, for example, the client device 202 or the like. The information processing device 100 may acquire the processing request by, for example, accepting an input of the processing request based on an operation input by a user. The information processing device 100 includes the storage unit. The information processing device 100 stores a predetermined algorithm for solving the problem in the storage unit based on the parameter related to the problem.

In response to the processing request, the information processing device 100 generates the quantum circuit information defining the target quantum circuit for solving the target problem. The information processing device 100 acquires the parameter related to the target problem based on, for example, the processing request. The information processing device 100 specifies a type of a partial circuit that appears twice or more in the target quantum circuit based on the predetermined algorithm and the acquired parameter. The information processing device 100 may specify a type of a partial circuit that appears at least once or more in the target quantum circuit based on the predetermined algorithm and the acquired parameter.

The information processing device 100 stores first circuit information in the storage unit, and stores second circuit information in the storage unit. The first circuit information enables generation of one partial circuit belonging to the specified type. The partial circuit is an element forming the target quantum circuit. The second circuit information defines the target quantum circuit by representing, for each specified type, at least one partial circuit belonging to the specified type by using reference information that enables reference to the first circuit information stored in the storage unit. The reference information is, for example, a label that identifies the first circuit information. The reference information is, for example, an address representing a storage location of the first circuit information stored in the storage unit. For example, the second circuit information may represent, for each specified type, all partial circuits belonging to the specified type by using the reference information that enables reference to the first circuit information stored in the storage unit.

For example, the information processing device 100 generates, for each specified type, only one piece of the first circuit information that enables generation of one partial circuit belonging to the specified type. The information processing device 100 generates the second circuit information with reference to, for example, the generated first circuit information. For example, the information processing device 100 stores, for each specified type, only one piece of the generated first circuit information in the storage unit, and stores the generated second circuit information in the storage unit. The information processing device 100 transmits quantum circuit information including a combination of the stored first circuit information and the stored second circuit information to the quantum calculation device 201.

The information processing device 100 receives a solution of the target problem from the quantum calculation device 201. The information processing device 100 outputs the solution of the target problem. The information processing device 100 transmits the solution of the target problem to, for example, the client device 202. The information processing device 100 may output the solution of the target problem, for example, in a manner that allows a user to refer to the solution. Examples of the information processing device 100 include a server, a PC, or the like.

The quantum calculation device 201 is a computer for performing quantum calculation. The quantum calculation device 201 receives quantum circuit information from the information processing device 100. The quantum calculation device 201 specifies a target quantum circuit based on the quantum circuit information, and executes the target quantum circuit to calculate a solution of a target problem. The quantum calculation device 201 transmits the calculated solution of the target problem to the information processing device 100. Examples of the quantum calculation device 201 include a quantum computer or the like.

The client device 202 is a computer used by an analyst who sets a target problem. The client device 202 generates a processing request for requesting generation of quantum circuit information. The client device 202 generates the processing request by, for example, accepting an input of the processing request based on an operation input by the analyst. The client device 202 transmits the generated processing request to the information processing device 100.

As a result of transmitting the processing request, the client device 202 receives a solution of the target problem from the information processing device 100. The client device 202 outputs the solution of the target problem. The client device 202 outputs the solution of the target problem, for example, in a manner that allows the analyst to refer to the solution. Examples of the client device 202 include a PC, a tablet terminal, a smartphone, or the like.

Here, a case has been described where the information processing device 100 is a computer different from the quantum calculation device 201. However, the present embodiment is not limited to this. For example, the information processing device 100 may have the function as the quantum calculation device 201, and may also operate as the quantum calculation device 201. Furthermore, here, a case has been described where the information processing device 100 is the computer different from the client device 202. However, the present embodiment is not limited to this. For example, the information processing device 100 may have the function as the client device 202, and may also operate as the client device 202.

### Hardware Configuration Example of Information Processing Device 100

Next, a hardware configuration example of the information processing device 100 will be described with reference to FIG. 3.

FIG. 3 is a block diagram illustrating the hardware configuration example of the information processing device 100. In FIG. 3, the information processing device 100 includes a central processing unit (CPU) 301, a memory 302, a network interface (I/F) 303, a recording medium I/F 304, and a recording medium 305. Furthermore, the respective components are coupled to each other by a bus 300.

Here, the CPU 301 performs overall control of the information processing device 100. The memory 302 includes, for example, a read only memory (ROM), a random access memory (RAM), a flash ROM, and the like. For example, the flash ROM or the ROM stores various programs, and the RAM is used as a work area for the CPU 301. The programs stored in the memory 302 are loaded into the CPU 301 to cause the CPU 301 to execute coded processing.

The network I/F 303 is coupled to the network 210 through a communication line, and is coupled to another computer via the network 210. Then, the network I/F 303 takes control of an interface between the network 210 and the inside, and controls input and output of data to and from the another computer. Examples of the network I/F 303 include a modem, a LAN adapter, or the like.

The recording medium I/F 304 controls reading and writing of data from and to the recording medium 305 under the control of the CPU 301. Examples of the recording medium I/F 304 include a disk drive, a solid state drive (SSD), a universal serial bus (USB) port, or the like. The recording medium 305 is a nonvolatile memory that stores data written under the control of the recording medium I/F 304. Examples of the recording medium 305 include a disk, a semiconductor memory, a USB memory, or the like. The recording medium 305 may be attachable to and detachable from the information processing device 100.

The information processing device 100 may include, for example, a keyboard, a mouse, a display, a printer, a scanner, a microphone, a speaker, and the like in addition to the components described above. Furthermore, the information processing device 100 may include a plurality of the recording medium I/Fs 304 and a plurality of the recording media 305. Furthermore, the information processing device 100 does not have to include the recording medium I/F 304 or the recording medium 305.

### Hardware Configuration Example of Quantum Calculation Device 201

Next, a hardware configuration example of the quantum calculation device 201 will be described with reference to FIG. 4.

FIG. 4 is a block diagram illustrating the hardware configuration example of the quantum calculation device 201. In FIG. 4, the quantum calculation device 201 includes a CPU 401, a memory 402, a network I/F 403, a recording medium I/F 404, and a recording medium 405. The quantum calculation device 201 further includes an operation device I/F 406 and an operation device 407. Furthermore, the respective components are coupled to each other by a bus 400.

Here, the CPU 401 performs overall control of the quantum calculation device 201. The memory 402 includes, for example, a ROM, a RAM, a flash ROM, and the like. For example, the flash ROM or the ROM stores various programs, and the RAM is used as a work area for the CPU 401. The programs stored in the memory 402 are loaded into the CPU 401 to cause the CPU 401 to execute coded processing.

The network I/F 403 is coupled to the network 210 through a communication line, and is coupled to another computer via the network 210. Then, the network I/F 403 takes control of an interface between the network 210 and the inside, and controls input and output of data to and from the another computer. Examples of the network I/F 403 include a modem, a LAN adapter, or the like.

The recording medium I/F 404 controls reading and writing of data from and to the recording medium 405 under the control of the CPU 401. Examples of the recording medium I/F 404 include a disk drive, an SSD, a USB port, or the like. The recording medium 405 is a nonvolatile memory that stores data written under the control of the recording medium I/F 404. Examples of the recording medium 405 include a disk, a semiconductor memory, a USB memory, or the like. The recording medium 405 may be attachable to and detachable from the quantum calculation device 201.

The operation device I/F 406 controls access to the operation device 407 under the control of the CPU 401. The operation device I/F 406 converts an output signal from the CPU 401 into an input signal to the operation device 407 by using a microwave pulse generator, and transmits the input signal to the operation device 407. The operation device I/F 406 converts an output signal from the operation device 407 into an input signal to the CPU 401 by using a microwave pulse demodulator, and transmits the input signal to the CPU 401. The operation device 407 is an operation device in which one or more qubit chips cooled to a cryogenic temperature of 10 mK are mounted. The qubit chip represents, for example, a logical qubit. The operation device 407 uses the one or more qubit chips to perform a predetermined operation according to an input signal, and outputs an output signal corresponding to a result of performing the predetermined operation.

The quantum calculation device 201 may include, for example, a keyboard, a mouse, a display, a printer, a scanner, a microphone, a speaker, and the like in addition to the components described above. Furthermore, the quantum calculation device 201 may include a plurality of the recording medium I/Fs 404 and the recording media 405. Furthermore, the quantum calculation device 201 does not have to include the recording medium I/F 404 or the recording medium 405.

### Hardware Configuration Example of Client Device 202

For example, since a hardware configuration example of the client device 202 is similar to the hardware configuration example of the information processing device 100 illustrated in FIG. 3, description thereof will be omitted.

### Functional Configuration Example of Information Processing Device 100

Next, a functional configuration example of the information processing device 100 will be described with reference to FIG. 5.

FIG. 5 is a block diagram illustrating the functional configuration example of the information processing device 100. The information processing device 100 includes a storage unit 510, an acquisition unit 501, a first storage unit 502, a second storage unit 503, and an output unit 504.

The storage unit 510 is implemented by, for example, a storage area such as the memory 302 or the recording medium 305 illustrated in FIG. 3. Hereinafter, a case will be described where the storage unit 510 is included in the information processing device 100. However, the present embodiment is not limited to this. For example, the storage unit 510 may be included in a device different from the information processing device 100, and the information processing device 100 may refer to content stored in the storage unit 510.

The acquisition unit 501 to the output unit 504 function as examples of a control unit 500. For example, the acquisition unit 501 to the output unit 504 implement functions thereof by causing the CPU 301 to execute a program stored in a storage area such as the memory 302 or the recording medium 305 illustrated in FIG. 3 or by the network I/F 303. A processing result of each functional unit is stored in, for example, a storage area such as the memory 302 or the recording medium 305 illustrated in FIG. 3.

The storage unit 510 stores various types of information to be referred to or updated in processing of each functional unit. The storage unit 510 stores, for example, an algorithm for solving a problem. For example, a predetermined algorithm specifies a target problem based on a parameter, and defines a series of processing parts for solving the target problem. The series of processing parts includes a processing part that repeats the same processing content, and the like. The predetermined algorithm is set in advance by a user, for example. The parameter is acquired by, for example, the acquisition unit 501.

The storage unit 510 stores quantum circuit information defining a quantum circuit for solving a problem. The quantum circuit information is, for example, a combination of one or more pieces of first circuit information and second circuit information. The first circuit information is, for example, circuit information that enables generation of one partial circuit. The second circuit information is, for example, circuit information that defines a quantum circuit by representing at least one partial circuit by using reference information that enables reference to the first circuit information. The first circuit information exists in order not to repeatedly define specific content of the same partial circuit in the second circuit information, and contributes to reducing memory usage of the quantum circuit information. The specific content is, for example, description of a relationship between each operation unit such as a gate forming the partial circuit and a qubit.

The acquisition unit 501 acquires various types of information to be used for processing of each functional unit. The acquisition unit 501 stores the acquired various types of information in the storage unit 510, or outputs the acquired various types of information to each functional unit. Furthermore, the acquisition unit 501 may output various types of information previously stored in the storage unit 510 to each functional unit. The acquisition unit 501 acquires various types of information based on, for example, an operation input by a user. The acquisition unit 501 may receive various types of information from, for example, a device different from the information processing device 100.

The acquisition unit 501 acquires, for example, a processing request. The processing request may include, for example, a parameter related to a target problem. For example, the acquisition unit 501 acquires the processing request by receiving the processing request from another computer. The another computer is, for example, the client device 202 or the like. For example, the acquisition unit 501 may acquire the processing request by accepting an input of the processing request based on an operation input by a user.

The acquisition unit 501 acquires, for example, the parameter related to the target problem. For example, the acquisition unit 501 acquires the parameter related to the target problem by extracting the parameter related to the target problem from the processing request. For example, the acquisition unit 501 may acquire the parameter related to the target problem by accepting an input of the parameter related to the target problem based on an operation input by a user. For example, the acquisition unit 501 acquires the parameter related to the target problem by receiving the parameter related to the target problem from another computer. The another computer is, for example, the client device 202 or the like.

The acquisition unit 501 may accept a start trigger to start processing of any one of the functional units. The start trigger is, for example, a predetermined operation input by a user. The start trigger may be, for example, reception of predetermined information from another computer. The start trigger may be, for example, output of predetermined information by any one of the functional units. For example, the acquisition unit 501 may accept acquisition of the processing request as a start trigger to start the processing of the first storage unit 502 and the second storage unit 503.

The first storage unit 502 specifies a type of at least any one of partial circuits that appear in a target quantum circuit. For example, the first storage unit 502 specifies a type of a partial circuit that appears twice or more in the target quantum circuit. The target quantum circuit is, for example, a quantum circuit that implements the quantum amplitude estimation. The type identifies, for example, a partial circuit that implements a predetermined function based on a predetermined algorithm. For example, the type may be defined in advance in the predetermined algorithm. For example, the type may be determined by the first storage unit 502 based on the predetermined algorithm.

The predetermined function is, for example, a function of a predetermined unit specified in the predetermined algorithm. The predetermined function is, for example, a function of a processing part that performs the same processing content twice or more. The predetermined function may be, for example, a function separated by the information processing device 100 from the entire function of the predetermined algorithm. In a case where the target quantum circuit is the quantum circuit that implements the quantum amplitude estimation, the predetermined functions are, for example, a function of generating a random number, a function of calculating an expected value of a payoff, a function of performing a Grover operation, and the like.

For example, the first storage unit 502 specifies, based on the predetermined algorithm and a parameter acquired by the acquisition unit 501, each processing part that performs the same processing content twice or more among a plurality of processing parts performed when the target problem is solved. For example, the first storage unit 502 specifies a type of a partial circuit that implements the processing content in the specified processing part. For example, in a case where the target quantum circuit implements the quantum amplitude estimation, the first storage unit 502 specifies at least any one of a type of a partial circuit that generates a random number, a type of a partial circuit that calculates an expected value of a payoff, and a type of a partial circuit that performs a Grover operation.

Therefore, the first storage unit 502 may determine which first circuit information enabling generation of which partial circuit is to be stored in the storage unit 510 in order to reduce memory usage of quantum circuit information. For example, the first storage unit 502 may determine that the first circuit information that enables generation of a partial circuit only for a type useful for reducing the memory usage of the quantum circuit information is to be stored in the storage unit 510. In the second circuit information, when specific content of the partial circuit that appears twice or more does not have to be repeatedly defined, this contributes to the reduction of the memory usage of the quantum circuit information. Therefore, the type of the partial circuit that appears twice or more is the type useful for the reduction of the memory usage of the quantum circuit information.

For example, the first storage unit 502 may specify types of all partial circuits that appear in the target quantum circuit. For example, the first storage unit 502 specifies, based on the predetermined algorithm and the parameter acquired by the acquisition unit 501, types of the respective plurality of processing parts to be performed when the target problem is solved as the types of the partial circuits. For example, in a case where the target quantum circuit is the quantum circuit that implements the quantum amplitude estimation, the first storage unit 502 specifies a type of a partial circuit that generates a random number, a type of a partial circuit that calculates an expected value of a payoff, and a type of a partial circuit that performs a Grover operation.

Therefore, the first storage unit 502 may determine which first circuit information enabling generation of which partial circuit is to be stored in the storage unit 510 in order to reduce the memory usage of the quantum circuit information. For example, the first storage unit 502 may determine that the first circuit information that enables generation of a partial circuit for all the types is to be stored in the storage unit 510.

The first storage unit 502 stores, for each specified type, only one piece of the first circuit information that enables generation of one partial circuit belonging to the specified type, in the storage unit 510. For example, the first storage unit 502 generates, for each specified type, only one piece of the first circuit information that represents specific content of the one partial circuit belonging to the specified type and that enables generation of the one partial circuit, and stores the first circuit information in the storage unit 510. Therefore, the first storage unit 502 may store the first circuit information in the storage unit 510 in order to reduce the memory usage of the quantum circuit information.

The second storage unit 503 generates second circuit information that defines a target quantum circuit by representing at least one partial circuit by using reference information that enables reference to first circuit information stored in the storage unit 510, and stores the second circuit information in the storage unit 510. The reference information is, for example, an address representing a storage location of the first circuit information stored in the storage unit 510. The reference information may be, for example, a label assigned to the first circuit information stored in the storage unit 510, or the like.

The second circuit information is, for example, information that defines the target quantum circuit by representing, for each specified type, at least one partial circuit belonging to a specified type by using the reference information that enables reference to the first circuit information stored in the storage unit 510. Therefore, the second storage unit 503 does not have to include specific content of the at least one partial circuit in the second circuit information. Thus, the second storage unit 503 may reduce memory usage of quantum circuit information as compared with a case where specific content of all partial circuits is included in the quantum circuit information.

The second circuit information is information that defines the target quantum circuit by representing, for each specified type, each partial circuit belonging to the specified type by using the reference information that enables reference to the first circuit information stored in the storage unit 510. Therefore, the second storage unit 503 does not have to include specific content of each of some partial circuits in the second circuit information. Thus, the second storage unit 503 may reduce the memory usage of the quantum circuit information as compared with the case where the specific content of all the partial circuits is included in the quantum circuit information.

The output unit 504 outputs a processing result of at least any one of the functional units. Examples of an output format include display on a display, print output to a printer, transmission to an external device by the network I/F 303, or storage to a storage area such as the memory 302 or the recording medium 305. Therefore, the output unit 504 may notify a user of the processing result of at least any one of the functional units to improve convenience of the information processing device 100.

The output unit 504 outputs, for example, first circuit information and second circuit information stored in the storage unit 510. The output unit 504 transmits, for example, a combination of the first circuit information and the second circuit information stored in the storage unit 510 as quantum circuit information to another computer that performs quantum calculation.

As a result of outputting the quantum circuit information by the output unit 504, the acquisition unit 501 may receive, from the another computer, a result of forming a target quantum circuit based on the first circuit information and the second circuit information and performing the quantum calculation by the another computer. The output unit 504 outputs, for example, the result of performing the quantum calculation. The output unit 504 outputs the result of performing the quantum calculation, for example, in a manner that allows a user to refer to the result.

### Flow of Operation of Information Processing System 200

Next, a flow of an operation of the information processing system 200 will be described with reference to FIG. 6.

FIG. 6 is an explanatory diagram illustrating the flow of the operation of the information processing system 200. In FIG. 6, the information processing device 100 performs parameter setting 601. For example, the information processing device 100 accepts setting of a parameter related to a target problem. Therefore, the information processing device 100 may enable specification of a plurality of processing parts to be performed when the target problem is solved.

The information processing device 100 stores a predetermined algorithm defining the plurality of processing parts to be performed when the target problem is solved. The information processing device 100 performs quantum circuit information generation 602. For example, the information processing device 100 generates quantum circuit information in which specific content of the same partial circuit is not repeatedly defined when a target quantum circuit is defined based on the predetermined algorithm and the parameter whose setting has been accepted. Specific examples of generating the quantum circuit information will be described later with reference to FIGS. 7 to 10. The information processing device 100 transmits the generated quantum circuit information to the quantum calculation device 201.

The quantum calculation device 201 receives the quantum circuit information from the information processing device 100. The quantum calculation device 201 performs quantum circuit construction 611. For example, the quantum calculation device 201 issues a qubit operation instruction based on the quantum circuit information, and actually constructs a quantum circuit using qubits. The quantum calculation device 201 performs quantum circuit execution 612. For example, the quantum calculation device 201 executes the constructed quantum circuit. For example, the quantum calculation device 201 transmits a result of executing the quantum circuit to the information processing device 100. Therefore, the information processing system 200 may execute the quantum circuit, and acquire the result of executing the quantum circuit.

Here, a prior classical computer recognizes the target quantum circuit not in units of partial circuits but in units of operation units such as gates. Thus, it is considered that the prior classical computer generates, even when the same partial circuit repeatedly appears in the target quantum circuit, quantum circuit information repeatedly defining the specific content of the partial circuit. Therefore, in the prior classical computer, there is a problem that memory usage of the quantum circuit information is easily increased. Similarly, in the prior classical computer, there is a problem that a processing time needed when the quantum circuit information is generated is easily increased.

For example, when a problem having practical significance related to price determination of a derivative option with complicated marketability is solved, a depth of a quantum circuit tends to increase, and the number of qubits forming the quantum circuit tends to increase. Thus, in the prior classical computer, when the problem having practical significance is solved, the memory usage of the quantum circuit information or the processing time needed when the quantum circuit information is generated increases.

In the prior classical computer, as a result of the memory usage of the quantum circuit information being larger than a maximum capacity of a memory, the quantum circuit information may not be able to be stored. In the prior classical computer, as a result of the processing time needed when the quantum circuit information is generated being longer than a realistic allowable time, it may be difficult to generate the quantum circuit information. In this manner, there is a problem that performance of the prior classical computer becomes a bottleneck, and it becomes difficult to solve the target problem depending on complexity of the target problem.

On the other hand, when it is assumed that the same partial circuit repeatedly appears in a target quantum circuit, the information processing device 100 does not have to repeatedly define the specific content of the same partial circuit in the quantum circuit information. Therefore, the information processing device 100 may reduce the memory usage of the quantum circuit information. For example, the information processing device 100 may easily suppress the memory usage of the quantum circuit information within a maximum capacity of the memory. Similarly, the information processing device 100 may reduce the processing time needed when the quantum circuit information is generated. For example, the information processing device 100 may easily suppress the processing time needed when the quantum circuit information is generated within the realistic allowable time. In this manner, the information processing device 100 may easily solve the target problem even when the target problem becomes complicated.

### Example of Operation of Information Processing Device 100

Next, an example of an operation of the information processing device 100 will be described with reference to FIGS. 7 to 10.

FIGS. 7 to 10 are explanatory diagrams illustrating examples of the operation of the information processing device 100. In the examples of FIGS. 7 to 10, a target problem is a problem related to price determination of a derivative option. The information processing device 100 stores, for example, a quantum calculation algorithm that estimates time development of a price of an underlying asset and determines a price of the derivative option.

The quantum calculation algorithm represents, for example, sequentially performing a step 1, a step 2, a step 3, and a step 4. The step 1 is processing of generating a random number that gives the time development of the price of the underlying asset. The random number is defined by, for example, a probability density function. The step 2 is processing of creating a function for calculating an expected value of a payoff at the time of exercising a right. The function represents, for example, solving Monte Carlo integration. The payoff is a revenue. The step 3 is processing of performing a Grover operation of encoding an expected value of the Monte Carlo integration into a probability that any one qubit takes 1.

The step 4 is processing of estimating the “probability of 1” by the quantum amplitude estimation.

Here, the information processing device 100 is needed to generate quantum circuit information defining a target quantum circuit including a partial circuit that implements the step 1, the step 2, and the step 3. Here, the number of qubits forming the target quantum circuit may exceed 8000, for example. Furthermore, a depth of the target quantum circuit may exceed 5.4×10\hat{ }7, for example. Therefore, the information processing device 100 tends to be needed to generate the quantum circuit information so as to reduce memory usage needed when the quantum circuit information is stored. Next, description of FIG. 7 will be made.

In FIG. 7, an example of a quantum circuit 700 for solving the problem related to the price determination of the derivative option will be described. As illustrated in FIG. 7, the quantum circuit 700 implements the maximum likelihood amplitude estimation. The quantum circuit 700 includes a probability density distribution circuit P, a payoff function circuit F, and a Grover operation circuit Q. For example, the quantum circuit 700 includes partial circuits 711, 721, 731, and the like including the probability density distribution circuit P and the payoff function circuit F. Furthermore, for example, the quantum circuit 700 includes partial circuits 712, 722, 732, and the like including one or more Grover operation circuits Q. Qⁿ represents that n pieces of Q are included.

Furthermore, for example, the quantum circuit 700 includes operation units 713, 723, 733, and the like. The information processing device 100 collectively performs post-processing on measurement results of the respective operation units 713, 723, and 733, thereby implementing the maximum likelihood amplitude estimation. Next, description of FIG. 8 will be made.

In FIG. 8, an example of a quantum circuit 800 for solving the problem related to the price determination of the derivative option in the case of the number of qubits=4 and an iterative index k of the Grover operation=3 will be described. The quantum circuit 800 is a specific example of the quantum circuit 700.

As illustrated in FIG. 8, the quantum circuit 800 includes quantum circuits 810, 820, 830, and 840. The quantum circuit 810 includes a partial circuit 811 serving as the probability density distribution circuit P. The quantum circuit 810 includes an operation unit 812. The quantum circuit 810 includes a partial circuit 813 serving as the payoff function circuit F. The quantum circuit 810 includes an operation unit 814. The quantum circuit 810 includes an operation unit 815.

The quantum circuit 820 includes a partial circuit 821 serving as the probability density distribution circuit P. The quantum circuit 820 includes an operation unit 822. The quantum circuit 820 includes a partial circuit 823 serving as the payoff function circuit F. The quantum circuit 820 includes a partial circuit 824 serving as the Grover operation circuit Q. The quantum circuit 820 includes an operation unit 825. The quantum circuit 820 includes an operation unit 826.

The quantum circuit 830 includes a partial circuit 831 serving as the probability density distribution circuit P. The quantum circuit 830 includes an operation unit 832. The quantum circuit 830 includes a partial circuit 833 serving as the payoff function circuit F. The quantum circuit 830 includes partial circuits 834 and 835 serving as the Grover operation circuits Q. The quantum circuit 830 includes an operation unit 836. The quantum circuit 830 includes an operation unit 837.

The quantum circuit 840 includes a partial circuit 841 serving as the probability density distribution circuit P. The quantum circuit 840 includes an operation unit 842. The quantum circuit 840 includes a partial circuit 843 serving as the payoff function circuit F. The quantum circuit 840 includes partial circuits 844 to 847 serving as the Grover operation circuits Q. The quantum circuit 840 includes an operation unit 848. The quantum circuit 840 includes an operation unit 849.

For example, in the quantum circuit 800, the Grover operation circuit Q appears a plurality of times as the partial circuits 824, 834, 835, and 844 to 847. Since before, the quantum circuit 800 is recognized not in units of the Grover operation circuits Q but in units of operation units such as gates. Since before, since specific content of each of all the partial circuits 824, 834, 835, and 844 to 847 is defined in the quantum circuit information, there is a problem that the memory usage of the quantum circuit information is easily increased. Therefore, the information processing device 100 generates the quantum circuit information so as not to define the specific content of at least any one of the partial circuits 824, 834, 835, and 844 to 847.

Similarly, for example, in the quantum circuit 800, the probability density distribution circuit P appears a plurality of times as the partial circuits 811, 821, 831, and 841. Similarly, for example, in the quantum circuit 800, the payoff function circuit F appears a plurality of times as the partial circuits 813, 823, 833, and 843. Furthermore, the information processing device 100 may recognize a combination of the operation units 814 and 815, a combination of the operation units 825 and 826, a combination of the operation units 836 and 837, a combination of the operation units 848 and 849, and the like as partial circuits that appear a plurality of times. Next, description of FIG. 9 will be made.

In FIG. 9, the information processing device 100 generates quantum circuit information defining a quantum circuit 900. The quantum circuit 900 corresponds to the quantum circuit 800 and the like. The quantum circuit 900 includes a partial circuit 901 serving as the probability density distribution circuit P, a partial circuit 902 serving as the payoff function circuit F, and partial circuits 903 and 904 serving as the Grover operation circuits Q.

For simplification of description, parts of the quantum circuit 900 corresponding to the operation units 812, 814, 815, and the like are omitted. Furthermore, for convenience of description, the quantum circuit 900 is illustrated in the example of FIG. 9, but the information processing device 100 does not have to specify the quantum circuit 900 itself for convenience of the maximum capacity of the memory. For example, the information processing device 100 preferably performs operations described below by analyzing what type of partial circuit appears in the quantum circuit 900 based on the quantum calculation algorithm without specifying the quantum circuit 900 itself.

(9-1) The information processing device 100 specifies a type of each of the plurality of partial circuits in functional units. For example, the information processing device 100 specifies a type of a partial circuit that appears at least once or more in functional units. In the example of FIG. 9, for example, the information processing device 100 specifies the probability density distribution circuit P, the payoff function circuit F, and the Grover operation circuit Q as the types.

(9-2) The information processing device 100 generates, for each specified type, partial circuit information that enables generation of one partial circuit of the type, and stores the partial circuit information in the memory. For example, the information processing device 100 stores the partial circuit information and an index of the partial circuit information in association with each other in a partial circuit information table 910 prepared in the memory. A specific example of content of the partial circuit information table 910 will be described later with reference to FIG. 11.

For example, the information processing device 100 generates partial circuit information 911 representing one partial circuit serving as the probability density distribution circuit P. For example, the information processing device 100 generates partial circuit information 912 representing one partial circuit serving as the payoff function circuit F. For example, the information processing device 100 generates partial circuit information 913 representing one partial circuit serving as the Grover operation circuit Q. Therefore, the information processing device 100 may store, for each type, only one specific content of the partial circuit for each type, and the specific content of the partial circuit does not have to be defined in the quantum circuit information.

(9-3) The information processing device 100 generates entire circuit information 920. For example, the information processing device 100 uses reference information that enables reference to the partial circuit information 911 to 913 to represent the various partial circuits 901 to 904, thereby generating the entire circuit information 920 defining the quantum circuit 900 without defining specific content of the various partial circuits 901 to 904. The reference information is, for example, indexes of the various partial circuits 901 to 904. The reference information may be, for example, addresses representing storage locations of the various partial circuits 901 to 904.

Therefore, the information processing device 100 may generate a combination of the entire circuit information 920 and the partial circuit information 911 to 913 as the quantum circuit information. When the information processing device 100 defines the specific content of the partial circuit only once in the quantum circuit information, the specific content of the partial circuit does not have to be repeatedly defined, and the memory usage of the quantum circuit information may be reduced.

Here, a case has been described where the information processing device 100 specifies the type of the partial circuit that appears at least once or more in functional units, and generates the partial circuit information for each specified type. However, the present embodiment is not limited to this. For example, the information processing device 100 may specify a type of a partial circuit that appears at least N times or more in functional units, and generates the partial circuit information for each specified type. N is an integer of 2 or more. In this case, the information processing device 100 does not have to generate the partial circuit information for a type of a partial circuit that appears less than N times, and may define specific content of the partial circuit that appears less than N times in the entire circuit information 920 as it is.

Here, a case has been described where the information processing device 100 specifies the probability density distribution circuit P, the payoff function circuit F, and the Grover operation circuit Q as the types. However, the present embodiment is not limited to this. For example, the information processing device 100 may recognize a combination of specific operation units as a partial circuit based on the quantum calculation algorithm, and specify a type of the partial circuit. Returning to the example of FIG. 8, for example, the specific combination of the operation units corresponds to the combination of the operation units 814 and 815, the combination of the operation units 825 and 826, the combination of the operation units 836 and 837, and the combination of the operation units 848 and 849. Next, description of FIG. 10 will be made.

In FIG. 10, prior quantum circuit information 1000 is compared with quantum circuit information generated by the information processing device 100. As illustrated in FIG. 10, in the prior quantum circuit information 1000, specific content of all partial circuits that appear a plurality of times is defined. Thus, a processing time needed when the quantum circuit information 1000 is generated tends to be long. Furthermore, memory usage of the quantum circuit information 1000 tends to increase.

On the other hand, the information processing device 100 may generate only one piece of partial circuit information defining a partial circuit for each type of the partial circuit, and store the partial circuit information in the memory. The information processing device 100 only needs to define specific content of a partial circuit that appears a plurality of times only once. Thus, the information processing device 100 may reduce a processing time needed when the quantum circuit information is generated.

Furthermore, the information processing device 100 may define, in the entire circuit information 920, how and how many times a partial circuit appears by using addresses 1011 to 1014 of the partial circuit information. Here, memory usage of the addresses 1011 to 1014 of the partial circuit information is smaller than memory usage of the partial circuit information. Thus, the information processing device 100 may reduce memory usage of the quantum circuit information.

### Example of Quantum Circuit Information

Next, an example of the quantum circuit information will be described with reference to FIGS. 11 and 12. In the examples of FIGS. 11 and 12, it is assumed that the quantum circuit information is a combination of a partial circuit information table 1100 and entire circuit information 1200.

FIGS. 11 and 12 are explanatory diagrams illustrating an example of the quantum circuit information. In FIG. 11, an example of the partial circuit information table 1100 forming the quantum circuit information will be described. As illustrated in FIG. 11, the partial circuit information table 1100 stores, in a range of any one of addresses in the memory, a partial circuit information index and partial circuit information content in association with each other.

A “memory address” in FIG. 11 is the address in the memory. The “partial circuit information index” in FIG. 11 indicates an index allocated to partial circuit information stored in the range of any one of the addresses in the memory. The “partial circuit information content” in FIG. 11 indicates specific content of the partial circuit information stored in the range of any one of the addresses in the memory. Next, description of FIG. 12 will be made.

In FIG. 12, an example of the entire circuit information 1200 forming the quantum circuit information will be described. As illustrated in FIG. 12, the entire circuit information 1200 stores the partial circuit information index in association with a combination of one or more qubits. “Qubits to be combined” in FIG. 12 indicates a combination of one or more qubits input to a partial circuit. The “partial circuit information index” in FIG. 12 indicates an index allocated to the partial circuit to which the one or more qubits is input.

### Example of Effects of Information Processing Device 100

Next, a possible result as an example of effects of the information processing device 100 will be described with reference to FIGS. 13 and 14.

FIGS. 13 and 14 are explanatory diagrams illustrating the possible result as an example of the effects of the information processing device 100. In the examples of FIGS. 13 and 14, it is assumed that the information processing device 100 generates quantum circuit information defining a target quantum circuit based on an algorithm obtained by extending the maximum likelihood amplitude estimation of Qiskit. Furthermore, as a comparative example of the information processing device 100, in a prior method, it is assumed that a target quantum circuit is distinguished for each operation unit of a minimum unit such as a gate, and a relationship between each operation unit and a qubit is comprehensively described, thereby generating quantum circuit information defining the target quantum circuit. Next, description of FIG. 13 will be made.

In FIG. 13, a graph 1300 illustrates, by a solid line, a ratio of a total processing time needed when the information processing device 100 generates the quantum circuit information to a total processing time needed when the quantum circuit information is generated by the prior method. The total processing time does not include a processing time for performing quantum calculation by the quantum calculation device 201. The graph 1300 illustrates, by a dotted line, a ratio of a function processing time needed when the information processing device 100 generates the quantum circuit information to a function processing time needed when the quantum circuit information is generated by the prior method. The function is a quantum circuit information generation function (construct_circuit). For example, the graph 1300 illustrates the ratio for each number of qubits in a case where k is constant at 5.

Furthermore, a graph 1310 illustrates, by a solid line, a ratio of the total processing time needed when the information processing device 100 generates the quantum circuit information to the total processing time needed when the quantum circuit information is generated by the prior method. The graph 1310 illustrates, by a dotted line, a ratio of the function processing time needed when the information processing device 100 generates the quantum circuit information to the function processing time needed when the quantum circuit information is generated by the prior method. The function is the quantum circuit information generation function (construct_circuit). For example, the graph 1310 illustrates the ratio for each value of k in a case where the number of qubits is constant at 7.

According to the graph 1300, in the case of k=5, the information processing device 100 may reduce the total processing time, the function processing time, or the like by 80% or more on average regardless of the number of qubits. According to the graph 1310, in the case of the number of qubits=7, the information processing device 100 may efficiently reduce the total processing time, the function processing time, or the like as the value of k increases. For example, the information processing device 100 may efficiently reduce the total processing time, the function processing time, or the like as the number of times of appearance of the same partial circuit increases. In this manner, the information processing device 100 may reduce the total processing time, the function processing time, or the like when the quantum circuit information is generated, as compared with the prior method. Next, description of FIG. 14 will be made.

In FIG. 14, a graph 1400 illustrates, by a solid line, a ratio of total memory usage needed when the information processing device 100 generates the quantum circuit information to total memory usage needed when the quantum circuit information is generated by the prior method. The graph 1400 illustrates, by a dotted line, a ratio of function memory usage needed when the information processing device 100 generates the quantum circuit information to function memory usage needed when the quantum circuit information is generated by the prior method. The function is the quantum circuit information generation function. For example, the graph 1400 illustrates the ratio for each number of qubits in a case where k is constant at 5.

Furthermore, a graph 1410 illustrates, by a solid line, a ratio of the total memory usage needed when the information processing device 100 generates the quantum circuit information to the total memory usage needed when the quantum circuit information is generated by the prior method. The graph 1410 illustrates, by a dotted line, a ratio of the function memory usage needed when the information processing device 100 generates the quantum circuit information to the function memory usage needed when the quantum circuit information is generated by the prior method. The function is the quantum circuit information generation function. For example, the graph 1410 illustrates the ratio for each value of k in a case where the number of qubits is constant at 7.

According to the graph 1400, in the case of k=5, the information processing device 100 may reduce the total memory usage, the function memory usage, or the like by 80% or more on average regardless of the number of qubits. According to the graph 1410, in the case of the number of qubits=7, the information processing device 100 may efficiently reduce the total memory usage, the function memory usage, or the like as the value of k increases. For example, the information processing device 100 may efficiently reduce the total memory usage, the function memory usage, or the like as the number of times of appearance of the same partial circuit increases. In this manner, the information processing device 100 may reduce the total memory usage, the function memory usage, or the like when the quantum circuit information is generated, as compared with the prior method.

### Overall Processing Procedure

Next, an example of an overall processing procedure executed by the information processing device 100 will be described with reference to FIG. 15. Overall processing is implemented by, for example, the CPU 301, a storage area such as the memory 302 or the recording medium 305, and the network I/F 303 illustrated in FIG. 3.

FIG. 15 is a flowchart illustrating an example of the overall processing procedure. In FIG. 15, the information processing device 100 specifies an algorithm for solving a target problem (step S1501).

The information processing device 100 specifies, based on the specified algorithm, one or more processing parts each representing processing content of one time of a different type among a plurality of processing parts performed when the target problem is solved (step S1502).

The information processing device 100 selects a processing part that has not yet been selected among the one or more specified processing parts (step S1503). The information processing device 100 generates partial circuit information defining a partial circuit representing processing content of one time of the selected processing part, and stores the partial circuit information in the memory (step S1504).

The information processing device 100 determines whether or not all the processing parts have been selected among the one or more specified processing parts (step S1505). Here, in a case where there is a processing part that has not yet been selected (step S1505: No), the information processing device 100 returns to the processing of step S1503. On the other hand, in a case where all the processing parts have been selected (step S1505: Yes), the information processing device 100 proceeds to processing of step S1506.

In step S1506, the information processing device 100 selects an address of partial circuit information that has not yet been selected from the memory (step S1506). The information processing device 100 adds a statement calling the partial circuit information existing at the selected address to quantum circuit information (step S1507).

The information processing device 100 determines whether or not the statement calling the partial circuit information existing at the selected address has been added for the number of times of repetition of processing content represented by the partial circuit information existing at the selected address (step S1508). Here, in a case where the addition has not been performed for the number of times of repetition (step S1508: No), the information processing device 100 returns to the processing of step S1507. On the other hand, in a case where the addition has been performed for the number of times of repetition (step S1508: Yes), the information processing device 100 proceeds to processing of step S1509.

In step S1509, the information processing device 100 determines whether or not addresses of all pieces of partial circuit information have been selected in the memory (step S1509). Here, in a case where there is an address of partial circuit information that has not yet been selected (step S1509: No), the information processing device 100 returns to the processing of step S1506. On the other hand, in a case where the addresses of all pieces of the partial circuit information have been selected (step S1509: Yes), the information processing device 100 proceeds to processing of step S1510.

In Step S1510, the information processing device 100 outputs the quantum circuit information (step S1510). The information processing device 100 transmits the quantum circuit information to, for example, the quantum calculation device 201. The information processing device 100 ends the overall processing. Therefore, the information processing device 100 may reduce memory usage of quantum circuit information. Here, the information processing device 100 may switch some steps in the processing order in FIG. 15 and execute the processing. Furthermore, the information processing device 100 may omit the processing of some steps in FIG. 15.

As described above, according to the information processing device 100, it is possible to specify a type of a partial circuit that appears twice or more in a target quantum circuit. According to the information processing device 100, it is possible to store, for each specified type, only one piece of first circuit information that enables generation of one partial circuit belonging to the specified type, in the storage unit 510. According to the information processing device 100, it is possible to store, in the storage unit 510, second circuit information defining a target quantum circuit by representing, for each specified type, at least one partial circuit belonging to the specified type by using reference information that enables reference to the first circuit information. Therefore, the information processing device 100 may reduce memory usage of the quantum circuit information. The information processing device 100 may reduce a processing time needed when the quantum circuit information is generated.

According to the information processing device 100, it is possible to store, in the storage unit 510, the second circuit information defining the target quantum circuit by representing, for each specified type, each partial circuit belonging to the specified type by using the reference information. Therefore, the information processing device 100 may further reduce the memory usage of the quantum circuit information. The information processing device 100 may further reduce the processing time needed when the quantum circuit information is generated.

According to the information processing device 100, it is possible to use an address representing a storage location of the first circuit information stored in the storage unit 510 as the reference information. Therefore, the information processing device 100 may implement the second circuit information by using the address.

According to the information processing device 100, it is possible to apply the information processing device 100 to the target quantum circuit for solving a target problem. Therefore, the information processing device 100 may generate the quantum circuit information defining the target quantum circuit for solving the target problem. The information processing device 100 may enable solving of the target problem.

According to the information processing device 100, it is possible to specify a processing part that performs the same processing content twice or more among a plurality of processing parts performed when the target problem is solved, and to specify a type of a partial circuit that implements the processing content in the specified processing part. Therefore, the information processing device 100 may efficiently specify the type of the partial circuit that appears twice or more in the target quantum circuit. The information processing device 100 may also be applied to a case where the type of the partial circuit that appears twice or more is not known.

According to the information processing device 100, it is possible to be apply the information processing device 100 to a case where the target quantum circuit is a quantum circuit that implements the quantum amplitude estimation. According to the information processing device 100, it is possible to specify at least any one of a type of a partial circuit that generates a random number, a type of a partial circuit that calculates an expected value of a payoff, and a type of a partial circuit that performs a Grover operation. Therefore, the information processing device 100 may easily specify the type of the partial circuit, and may reduce the processing time.

According to the information processing device 100, it is possible to transmit the first circuit information and the second circuit information stored in the storage unit 510 to another computer that performs quantum calculation. According to the information processing device 100, as a result of the transmission, it is possible to receive, from the another computer, a result of forming the target quantum circuit based on the first circuit information and the second circuit information and performing the quantum calculation by the another computer. Therefore, the information processing device 100 may automatically perform the quantum calculation.

The information processing device 100 may improve user convenience.

Note that the information processing method described in the present embodiment may be implemented by executing a program prepared in advance in a computer such as a PC or a workstation. The information processing program described in the present embodiment is recorded in a computer-readable recording medium, and is read from the recording medium by a computer to execute the program. The recording medium is a hard disk, a flexible disk, a compact disc (CD)-ROM, a magneto optical disc (MO), a digital versatile disc (DVD), or the like.

Furthermore, the information processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a quantum circuit information generation program for causing a computer to execute processing comprising:
in generating of quantum circuit information indicating a target quantum circuit that includes a plurality of partial circuits,
specifying, for each partial circuits of the plurality of partial circuits included in the target quantum circuit, a type of the each partial circuit;
storing, for each specified type of one or more of specified types obtained by performing the specifying for the plurality of partial circuits, only one piece of first circuit information in a memory of the computer, the first circuit information including a configuration to generate any one partial circuit of partial circuits that belong to the specified type; and
generating, by using one or more pieces of reference information, second circuit information that defines the target quantum circuit to store the generated second circuit information in the memory, each piece of the one or more pieces of reference information being information that includes a reference to the first circuit information associated with a corresponding type of the one or more of specified types, the generating of the second circuit information including converting, in the second circuit information, at least one or more partial circuits belonging to any one type of the one or more of specified types among the plurality of partial circuits included in the target quantum circuit to a representation using a corresponding piece of reference information among the one or more pieces of reference information.

2. The non-transitory computer-readable recording medium according to claim 1, wherein the second circuit information is information that defines the target quantum circuit by representing, for each specified type, each partial circuit that belongs to the specified type by using a piece of reference information corresponding to the specified type.

3. The non-transitory computer-readable recording medium according to claim 1, wherein each piece of the one or more pieces of reference information includes an address that represents a storage location of the first circuit information associated with a corresponding type among the one or more of specified type.

4. The non-transitory computer-readable recording medium according to claim 1, wherein the target quantum circuit is a quantum circuit configured to solve a target problem.

5. The non-transitory computer-readable recording medium according to claim 4, wherein,
the specifying of the type of the each partial circuit includes:
specifying, from among a plurality of processing parts to be performed when the target problem is solved, a processing part that performs a processing content twice or more, and
specifying, as the type of the each partial circuit, a type of a partial circuit configured to implement the processing content in the specified processing part.

6. The non-transitory computer-readable recording medium according to claim 1, wherein
the target quantum circuit is a quantum circuit configured to implement quantum amplitude estimation, and
each of the one or more of specified types is any one of: a type of a partial circuit configured to generate a random number, a type of a partial circuit configured to perform a Grover operation, or a combination of the both types.

7. A quantum circuit information generation method implemented by a computer, comprising:
in generating of quantum circuit information indicating a target quantum circuit that includes a plurality of partial circuits,
specifying, for each partial circuits of the plurality of partial circuits included in the target quantum circuit, a type of the each partial circuit;
storing, for each specified type of one or more of specified types obtained by performing the specifying for the plurality of partial circuits, only one piece of first circuit information in a memory of the computer, the first circuit information including a configuration to generate any one partial circuit of partial circuits that belong to the specified type; and
generating, by using one or more pieces of reference information, second circuit information that defines the target quantum circuit to store the generated second circuit information in the memory, each piece of the one or more pieces of reference information being information that includes a reference to the first circuit information associated with a corresponding type of the one or more of specified types, the generating of the second circuit information including converting, in the second circuit information, at least one or more partial circuits belonging to any one type of the one or more of specified types among the plurality of partial circuits included in the target quantum circuit to a representation using a corresponding piece of reference information among the one or more pieces of reference information.

8. An information processing apparatus comprising:
a memory; and
a processor coupled to the memory, the processor being configured to perform processing including:
in generating of quantum circuit information indicating a target quantum circuit that includes a plurality of partial circuits,
specifying, for each partial circuits of the plurality of partial circuits included in the target quantum circuit, a type of the each partial circuit;
storing, for each specified type of one or more of specified types obtained by performing the specifying for the plurality of partial circuits, only one piece of first circuit information in the memory, the first circuit information including a configuration to generate any one partial circuit of partial circuits that belong to the specified type; and
generating, by using one or more pieces of reference information, second circuit information that defines the target quantum circuit to store the generated second circuit information in the memory, each piece of the one or more pieces of reference information being information that includes a reference to the first circuit information associated with a corresponding type of the one or more of specified types, the generating of the second circuit information including converting, in the second circuit information, at least one or more partial circuits belonging to any one type of the one or more of specified types among the plurality of partial circuits included in the target quantum circuit to a representation using a corresponding piece of reference information among the one or more pieces of reference information.
